(19) United States
(12) Patent Application Publication
(10) Pub. No.: US 2004/0203574 A1
(43) Pub. Date: Oct. 14, 2004

(54) Emergency call back method applicable to non-coded mobile stations

(76) Inventors: Mary W. Chin, Westmont, IL (US); Douglas H. Rollender, Bridgewater, NJ (US)

Correspondence Address: HARNESS, DICKEY & PIERCE, P.L.C., P.O. Box 8910, Reston, VA, 20195, US

(21) Appl. No.: 10/340,706

(22) Filed: Jan. 13, 2003

(51) Int. Cl. H04M 11/00; H04Q 7/20

(52) U.S. Cl. 455/404.1; 455/458; 455/426.1

(57) ABSTRACT

When a switch in a wireless network receives an emergency call from a mobile station lacking a unique identifier (a non-coded mobile station) assigned by a service provider, the switch stores the mobile equipment identity (MEID) of the mobile station in association with the default, non-unique identifier of the mobile station in a mapping table. The switch routes the emergency call to a Public Service Answering Point (PSAP) and sends an emergency routing number assigned to the switch as the calling party number. The switch also signals the MEID of the mobile station to the PSAP. If the emergency call drops, the PSAP performs a call back to the emergency routing number and supplies the MEID of the mobile station associated with the call back. The switch, upon receiving a call back using its emergency routing number, accesses the default mobile station identifier from the mapping table using the MEID, and pages the mobile station using the default mobile station identifier. The switch will complete the call back to a mobile station responding to the page if the mobile station has an MEID that matches the MEID of the call back. Besides non-coded mobile stations, the methodology is also applicable to coded mobile stations.

### BACKGROUND OF THE INVENTION

Emergency service calls in North America are originated by dialing “9-1-1.” Other parts of the world may use some other abbreviated string of dialable digits such as “6-1-1” in Mexico; all share the intent to provide the caller with an easy way to call for help with an easy to remember number. These calls are routed to a local Public Service Answering Point (PSAP) where an emergency response may be initiated (police, fire department, road repair, ambulance, etc.) while the caller is kept on the phone. If the call is somehow disconnected or dropped before the emergency is completely reported or the responder arrives, the PSAP may call back the originator using a call back number provided through its databases.

For example, the call record for a 911 call originated through a wired network may include Automatic Line Identification (ANI) or the telephone number of the access line from which the call originated. However, the mobile directory number (MDN) or telephone number of a wireless subscriber is not associated with a physical line or mobile station. Instead, calls to a wireless subscriber are routed to the mobile station by way of the mobile station identification (MSID), not the MDN. Accordingly, performing an emergency call back to a mobile station poses hurdles not encountered with, e.g., land line devices.

Typically, the MSID is either a 10-digit mobile identification number (MIN) or a 15-digit International Mobile Subscriber Identifier (IMSI) programmed into a mobile station by the service provider with whom the mobile station user has entered into a service agreement. Accordingly, the MSID is not necessarily a dialable number.

The MDN of a mobile station is a dialable number. The MDN is dialed by a caller and used to route a call through the network to the wireless subscriber's home system. At the subscriber's home system, the home location register (HLR) contains the MSID associated with the subscriber's MDN. The MSID, not the MDN, is then used to route the call through the network to the serving wireless system and page the subscriber. The subscriber's MDN is provided by the home system to the serving system in a separate data file called the subscriber profile.

The use of a separate number for MDN and MSID is new to some systems. Historically, in TIA/EIA-41 systems before the implementation of wireless number portability (WNP) or thousands block number pooling (TBNP) based on the Local Routing Number (LRN) method and international roaming (IR), the mobile identification number (MIN) of a mobile station was the same as the MDN. However, with WNP and TBNP, the MDN became “portable” or “poolable” from one service provider to another service provider. Since MSID is not portable or poolable, the recipient service provider assigns a new MSID for a subscriber with a ported-in or pooled MDN.

International roaming also forced the separation of MSID and MDN. While the MIN is a 10-digit number modeled after the North American Numbering Plan's 10-digit MDN, other nation's carriers using a different directory numbering plan may not allow their MDN to be equivalent to the internationally recognized MIN format. Another standard MSID is the IMSI. It is used in both TIA/EIA-41 and GSM systems around the world. IMSI is a 15-digit non-dialable number based on ITU-T Recommendation E.212, and therefore, can not serve as a 10-digit MDN.

Historically, when the MDN was the same as the MIN, the MIN would be delivered to a PSAP and would be used for a call back number. With the separation of MIN and MDN as described above, it became necessary to deliver the MDN as a separate call back number to the PSAP as well as the caller's MSID. There are certain problems associated with implementing this solution. The primary problem is that the serving system may not have the caller's MDN, only the MSID, to present to the PSAP with the call. Some of the reasons for this relate to the way MSID-MDN separation has been implemented according to standards.

An old serving TIA/EIA-41 system may not support WNP, TBNP or IR. This means that the older serving system may be expecting the MIN and the MDN to be the same. The older system would not even know to look for a separate MDN in the subscriber's service profile (keyed on MIN, not MDN). With this limitation, these subscribers may not be allowed to use basic services, but they must be allowed to call for emergency services. As a result, a roamer who dials “9-1-1” while on an old system will have his or her call delivered to the PSAP with an MSID but no MDN. Accordingly, no call back is possible.

A newer serving system that is WNP and IR capable may not be able to deliver MDN to the PSAP. This could happen if the calling mobile station is not registered with any service provider (e.g., there are mobile phones used for emergency calls only). It is also possible for a subscriber to place an emergency call before the HLR has responded to the serving system with the subscriber's service profile containing the MDN.

The call back MDN for an international roamer would require the PSAP to place an international call to reach a subscriber in their local Emergency Service Zone (ESZ). This is not a practical, timely or sufficiently reliable solution for a PSAP that normally does not place international calls and may require immediate call back information in order to save someone's life. In addition, the entire international MDN (up to 15 digits including a country code) may not be presented to the PSAP for call back if the PSAP only supports 10 digits.

It is also possible that the calling mobile station is not registered with any service provider. As a result, there may be no MDN associated with the mobile station or no permanent MSID encoded in the mobile station—such mobile stations are called non-coded mobile stations MSnc. This could be because (a) the MSnc was never intended to be registered (there are such phones to use for emergency calls only), (b) the phone is new and has not yet been initialized by a service provider or (c) the subscription has expired and the MSnc is no longer registered with a service provider.

Some mobile phones also support a removable User Identity Module (R-UIM) or Subscriber Identity Module (SIM) that may contain the MSID and the MDN. If the R-UIM or SIM are not in the MSnc, then the MSnc can still be used to place an emergency call. However, there is no MDN or MSID known to the MSnc or the serving system to provide the PSAP as a call back number.

Every MS contains a unique mobile equipment identity (MEID) encoded in the phone by the manufacturer. The MEID may be, for example, an electronic serial number (ESN) as used in ANSI/TIA/EIA-41 systems or an International Mobile Equipment Identity (IMEI) used in GSM systems. The MEID is independent of the MSID and MDN. The MEID is signaled over the air between the mobile station and the base station of a wireless system with a call origination attempt or soon thereafter. For example, if not supplied with the call origination attempt, the MEID is requested by the serving system.

Current standards for wireless emergency services call for delivering “911+the last seven digits of the MEID” to the PSAP as the call back number when the mobile directory number assigned to the mobile station is not available. While this may serve to identify the call to the PSAP and the serving system, this “911+MEID7” is not routable through the network and is not unique since it does not contain a complete MEID.

### SUMMARY OF THE INVENTION

The call back method according to the present invention assigns an emergency local routing number (ELRN) to each switch in a wireless network. When a switch of the wireless network routes an emergency call to a Public Service Answering Point (PSAP), the switch sends the emergency local routing number as the calling party number (CgPN) and provides the PSAP with the mobile equipment identity (MEID) of the mobile station. The switch also stores the MSID of the mobile station in association with the MEID. If the emergency call drops, the PSAP performs a call back using the emergency routing number as the called party number (CdPN). As a result the switch that routed the emergency call from the mobile station to the PSAP receives the call back. The PSAP also sends the MEID of the mobile station to the switch. The switch uses the MEID to access the associated MSID. This associated MSID is used to page the mobile station. In an embodiment of the present invention, the PSAP signals the MEID to the switch in a generic address parameter.

When the switch receives a page response, a MEID of the responding mobile station is supplied or obtained through request. The switch determines whether the MEID of the responding mobile matches the MEID of a paged mobile station. If the MEIDs match, the emergency call back is completed; otherwise, the page response is ignored. Because, for example, non-coded mobile stations use a default MSID that is not necessarily unique, this MEID match test prevents the switch from erroneously completing the emergency call back to the wrong mobile station.

By using the ELRN as discussed above, emergency call backs are routable through the network to the serving switch. By using the MEID to identity the mobile station and screen page responses, emergency call backs are correctly completed—even to non-coded mobile stations.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIGS. 1-6 are communication flow diagrams illustrating an example of the operation of the call back method according to the present invention.

### DETAILED DESCRIPTION OF EMBODIMENTS

The call back method according to the present invention assigns a unique routable call back number to each switch (e.g., a mobile switching center (MSC)) in a wireless communication system. This number will be referred to as an “Emergency Local Routing Number” or ELRN hereafter. The ELRN can be thought of as similar to the local routing number (LRN) assigned to each local switch to implement wireless number portability (WNP) or thousands block number pooling (TBNP). However, an ELRN can only be routed to the switch that owns the number, and the ELRN for each switch is unique and is not portable.

As is known, when a mobile station makes an emergency call, the mobile station identifier (MSID) is supplied in association with the emergency call. For example, the MSID is the mobile identification number (MIN), a ten digit International Roaming Mobile Identification Number (IRM) for those 10 digit numbers outside the range of the North American Numbering Plan, or the International Mobile Subscriber Identifier (IMSI). As discussed above, there exist mobile stations with no permanent MSID encoded therein—so-called non-coded mobile stations MSnc. Every MSnc, however, should contain a default MSID (dMSID) used to identify and address (i.e., page) a MSnc in special circumstances such as when the MSnc is being activated by a service provider and encoded over the air for general use. It may also be used to page a MSnc to deliver an emergency call back.

The dMSID is standardized for some mobile phones. For example, for a CDMA MSnc used in ANIS/TIA/EIA-41 systems, the dMSID is a string of “0”s followed by the last four digits of the MEID. The dMSID can only be used to page a MSnc with caution since there is no complete certainty that a dMSID is unique.

According to the methodology of the present invention, a switch of the wireless system receives an emergency call (e.g., a 9-1-1 call) from a non-coded mobile station MSnc, the switch stores the full MEID and dMSID of the MSnc in a mapping table. The switch sends the ELRN of the switch to the Public Service Answering Point (PSAP) serving the switch. The switch supplies the ELRN as the calling party number (CgPN), and also provides the PSAP with the MEID of the MSnc (e.g., in the ISUP generic address parameter).

If the emergency call drops, the PSAP performs a call back using the ELRN as the called party number (CdPN). As a result, the switch that routed the emergency call from the MSnc to the PSAP receives the call back. The PSAP also sends MEID of the mobile station to the switch. For example, the MEID is signaled with the call back such as in the ISUP generic address parameter (GAP).

When a switch receives its emergency routing number as the called party number, the switch recognizes an emergency call back situation. The MEID received with the call back is used by the switch to find the associated dMSID in the mapping table, and the dMSID is then used to page the MSnc. This ELRN technique may also be provisioned with priority queuing in the switches; wherein the switch handles the emergency call back at a higher priority than tasks involving other calls. This should improve the emergency call back completion rate even during peak traffic periods at the switch. Furthermore, while described as performed for emergency calls made by mobile stations with no or unavailable MDNs and/or no permanent MSID, the present invention is not limited in application to MSnc. Instead, the method of the present invention could be applied to emergency calls made by any and every mobile station (e.g., mobile stations with permanent MSIDs). In applying the methodology to any mobile station, the mapping table stores the MEID of the mobile station in association with the MSID (default or permanent).

When the MSnc answers the page, it provides the switch (e.g., MSC) with its full MEID (in the page response or in response to a request). If the MEID in the page response does not match the MEID from the PSAP call back/ISUP message, then the page response is ignored. The MSC continues to wait for another page response from the intended MSnc. When the MEID in a page response matches the MEID in the PSAP call back/ISUP message, then the MSnc that originated the emergency call has responded to the page. The emergency call back from the PSAP is then delivered to that MSnc. This MEID match test prevents the switch from erroneously completing the emergency call back to the wrong mobile station.

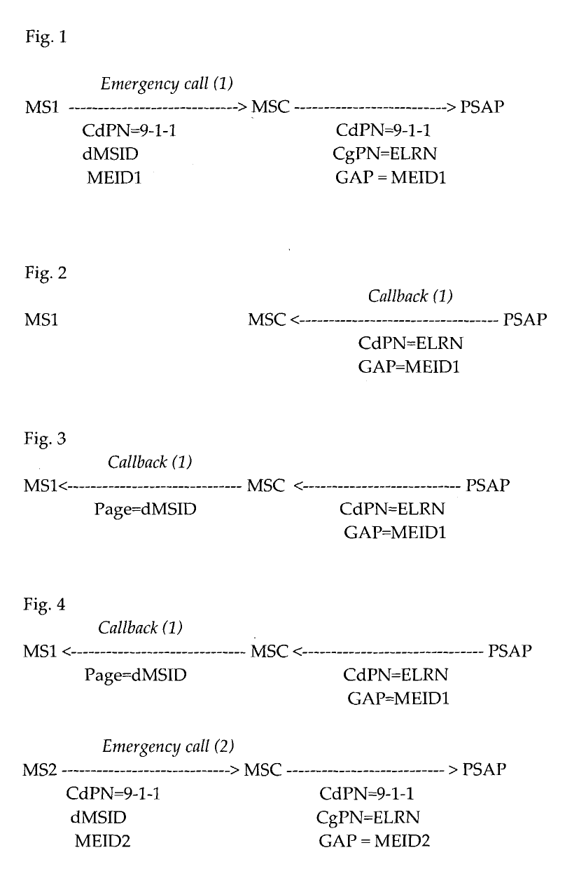

FIGS. 1-6 are communication flow diagrams illustrating the operation of the emergency call back method according to the present invention. As shown in FIG. 1, a first non-coded mobile station MS1 places an emergency call, a 9-1-1 call in this example, that is received by a MSC. Accordingly, the called party number is 9-1-1, the default MSID dMSID and the MEID1 of the first non-coded mobile station MS1 is supplied to the MSC as well. The MSC records the dMSID in association with the MEID1 in the mapping table, and routes the emergency call to the serving PSAP. In so doing, the called party number remains 9-1-1, but the MSC supplies its ELRN as the calling party number. The MSC also supplies the MEID1 of the first mobile station MS1 in the generic address parameter (GAP).

If the emergency call is dropped, the PSAP performs a call back using the ELRN as the called party number because the ELRN was supplied to the PSAP as the calling party number. The result is that the call back is routed to the MSC as shown in FIG. 2. As further shown in FIG. 2, the MEID1 of the first mobile station is signaled with the call back in the ISUP GAP. The MSC uses the MEID1 to retrieve the associated dMSID from the mapping table. As shown in FIG. 3, the MSC then uses the retrieved dMSID of the first non-coded mobile station MS1 to page the first mobile station MS1.

Assume that while the call back to the first mobile station MS1 is in progress, a second mobile station MS2 places a 9-1-1 emergency call as shown in FIG. 4. As with the emergency call from the first mobile station MS1, the second mobile station MS2 supplies its default mobile station identifier dMSID and mobile equipment identify MEID2 along with the emergency call (e.g., called party number is 9-1-1). As shown, the default mobile station identifier dMSID for the second non-coded mobile station MS2 is the same as the default mobile station identifier dMSID for the first non-coded mobile station MS1. The MSC stores the default mobile station identifier dMSID for the second non-coded mobile station MS2 in association with the mobile equipment identity MEID2 of the second non-coded mobile station MS2 in the mapping table. Then, the MSC routes the emergency call to the PSAP. In so doing, the called party number remains 9-1-1, but the MSC supplies its ELRN as the calling party number. The MSC also supplies the MEID2 of the second mobile station MS2 to the PSAP. Accordingly, FIG. 4 demonstrates that the MSC supplies the same calling party number (i.e., the ELRN) to the PSAP for both of the emergency calls.

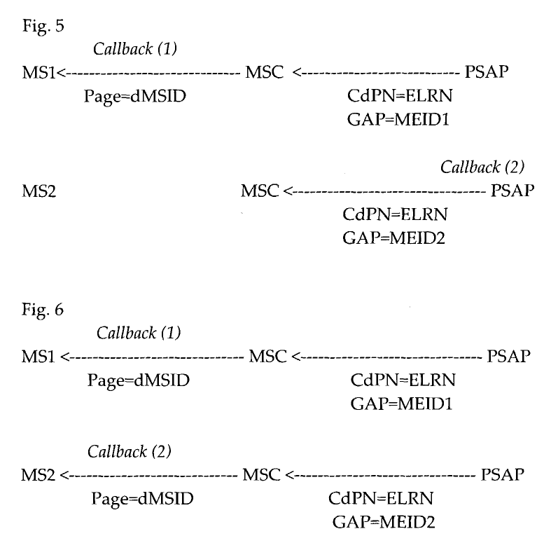

If the second emergency call is dropped, the PSAP performs a call back using the ELRN as the called party number because the ELRN was supplied to the PSAP as the calling party number. The result is that a second call back is routed to the MSC as shown in FIG. 5. As further shown in FIG. 5, the MEID2 of the second non-coded mobile station MS2 is signaled with the second call back in the ISUP GAP. The MSC uses the MEID2 of the second non-coded mobile station MS2 to retrieve the default mobile station identifier dMSID from the mapping table. As shown in FIG. 6, the MSC then uses the dMSID of the second mobile station MS2 to page the second mobile station MS2.

If the second non-coded mobile station MS2 replies to the page for the first non-coded mobile station MS1, the MEID2 is included in or with that page response or obtained by request. The MSC determines that the MEID2 of the page response from the second non-coded mobile station MS2 matches the mobile equipment identity in the GAP for the second call back. Accordingly, the MSC delivers the second call back to the second non-coded mobile station MS2 through a traffic channel assigned to the second non-coded mobile station MS2.

If a third non-coded mobile station MS3 with the same default mobile station identifier dMSID as the first and second non-coded mobile stations MS1 and MS2 replies to the page for the first non-coded mobile station MS1, the mobile equipment identifier MEID3 for the third non-coded mobile station MS3 will be included in or with the page response or will be obtained by request. However, the MSC will ignore this page response because the MEID3 does not match the mobile equipment identifiers in any of the pending call backs.

When or if the first non-coded mobile station MS1 sends a response to the page—for either the first or second non-coded mobile station MS1 or MS2, MEID1 is included in or with that page response or obtained by request. The MSC determines that the MEID1 of the page response from the first non-coded mobile station MS1 matches the mobile equipment identity in the GAP for the first call back. Accordingly, the MSC delivers the first call back to the first non-coded mobile station MS1 through a traffic channel assigned to the first non-coded mobile station MS1.

The emergency call back method of the present invention ensures a routable call back number is provided to a PSAP with every emergency call from a mobile station. Specifically, the ELRN is one number used to route one or many emergency service call backs to the originating switch (e.g., MSC). The ELRN of the originating switch is signaled to the PSAP as the calling party number (CgPN), particularly when there is no local MDN available to accompany an emergency call and/or no permanent MSID at the mobile station.

In the North American Numbering Plan, the ELRN is a 10-digit number (NPA-NXX-XXXX) where the leading 6-digits (NPA-NXX) are uniquely assigned to each local switch in North America for call routing purposes. The subsequent four digits are assigned by the switch operator. However, the emergency call back method is applicable in a public switched network anywhere in the world. Namely, the ELRN contains those digits assigned from any national numbering plan to route calls to a particular switch. Also, the emergency call back method may be applied with any mobile service or wireless access technology.

The emergency call back method is independent of number portability and number pooling. These network capabilities depend upon the Local Routing Number (LRN) Method to route a call to a serving switch based on the LRN associated with a ported or pooled dialed number. In comparison, the ELRN is not associated with a dialed number, instead it is associated with a switch.

In some ways, the ELRN functions in the public network like the Local Routing Number (LRN) required for local number portability; for instance, both function as a single number to route many calls to a particular switch. However, no database query is required to identify the ELRN required to route a call to a serving MSC. As a result, when used as the called party number (CdPN) to route a call back from a PSAP to the serving MSC, the ELRN may be accompanied with the ISUP Forward Call Indicator (FCI) set to indicate no number portability database query is required. Namely, while the ELRN is not portable, the ELRN may have come from a pooled number block, and an indication is made in the network signaling message to set up the call such that no number portability/pooling query is to be performed.

As discussed above, an ELRN is not associated with any particular MDN and is used to route a call back directly to the serving switch, not the home system. The ELRN eliminates the need for the PSAP to use a MDN to place an emergency call back. There is no need to request an MDN or an LRN to route a call back through a home system as per existing mobile application part (MAP) standards. Also, there is no need to place an international call through a foreign home system to call back an international roamer in the local area. This reduces signaling, saves time and improves service reliability. Further, there is no need for a Temporary Local Directory Number (TLDN), as in TIA/EIA-41 networks, or a Mobile Station Routing Number (MSRN), as in GSM networks, to route a call back from the home system to the serving system. This reduces signaling, saves time and places no demand on the supply of TLDNs or MSRNs.

The invention being thus described, it will be obvious that the same may be varied in many ways. Such variations are not to be regarded as a departure from the spirit and scope of the invention, and all such modifications are intended to be included within the scope of the following claims.

We claim:

1. An emergency call back method, comprising:
assigning an emergency routing number to a switch in a wireless network for use as the calling party number of emergency wireless calls routed to a Public Service Answering Point (PSAP) by the switch; and
maintaining a mapping table at the switch, the mapping table mapping a mobile station identifier of a mobile station in an emergency call with a mobile equipment identity of the mobile station.

2. The method of claim 1, wherein each assigned emergency routing number is not portable.

3. The method of claim 1, wherein the mobile station identifiers in the mapping table are default mobile station identifiers.

4. An emergency call back method, comprising:
sending an emergency routing number of a switch in a wireless network handling communication needs of a mobile station initiating an emergency call and a mobile equipment identity of the mobile station to a Public Service Answering Point (PSAP).

5. The method of claim 4, further comprising:
storing a mobile station identifier of the mobile station in association with the mobile equipment identity in a mapping table at the switch.

6. The method of claim 5, further comprising:
receiving an emergency call from the mobile station; and
performing the storing and sending steps in response to the received emergency call from the mobile station.

7. The method of claim 6, wherein the mobile station identifiers in the mapping table are default mobile station identifiers.

8. The method of claim 4, wherein the switch is a mobile switching center.

9. An emergency call back method, comprising:
receiving an emergency routing number of a switch in a wireless network handling communication needs of a mobile station initiating an emergency call and a mobile equipment identity of the mobile station at a Public Service Answering Point (PSAP);
initiating a call back to the mobile station by calling the emergency routing number when the emergency call made by the mobile station drops; and
signaling the mobile equipment identity of the mobile station to the switch when initiating the call back.

10. The method of claim 9, wherein the signaling step sends the mobile equipment identity in a generic address parameter.

11. An emergency call back method, comprising:
receiving, at a switch of a wireless communication system, a called party number and a mobile equipment identity; and
paging the mobile station identified by the mobile equipment identity when the called party number matches an emergency routing number assigned to the switch.

12. The method of claim 11, wherein the receiving step receives the mobile equipment identity in a generic address parameter.

13. The method of claim 11, wherein the paging step is performed with priority over other tasks at the switch.

14. The method of claim 11, wherein the switch is a mobile switching center.

15. The method of claim 11, wherein the paging step comprises:
retrieving a mobile station identifier for the mobile station from a mapping table using the received mobile equipment identity; and
paging the mobile station using the retrieved mobile station identifier.

16. The method of claim 15, wherein the mobile station identifiers in the mapping table are default mobile station identifiers.

17. The method of claim 11, further comprising:
receiving a page response and a mobile equipment identity from a responding mobile station at a switch; and
completing a call back for an emergency call to the responding mobile station in response to the page response when the mobile equipment identity of the responding mobile station matches a mobile equipment identity received in association with a called party number that matches the emergency routing number assigned to the switch.

18. The method of claim 17, further comprising:
ignoring the page response when the mobile equipment identity of the responding mobile station does not match a mobile equipment identity received in association with a called party number that matches the emergency routing number assigned to the switch.

19. An emergency call back method, comprising:
receiving a page response and a mobile equipment identity from a responding mobile station at a switch; and
completing a call back for an emergency call to the responding mobile station in response to the page response when the mobile equipment identity of the responding mobile station matches a mobile equipment identity received in association with a called party number that matches an emergency routing number assigned to the switch.

20. The method of claim 19, comprising:
ignoring the page response when the mobile equipment identity of the responding mobile station does not match a mobile equipment identity received in association with a called party number that matches the emergency routing number assigned to the switch.
